(19) United States
(12) Patent Application Publication
(10) Pub. No.: US 2003/0053850 A1
(43) Pub. Date: Mar. 20, 2003

(54) Penlatch notebook

(76) Inventors: Michael Dela Cruz, Eagle Rock, CA (US); Thomas G. Bell, Portland, OR (US)

Correspondence Address: Kirton & McConkie, 1800 Eagle Gate Tower, 60 East South Temple, Salt Lake City, UT, 84111, US

(21) Appl. No.: 10/223,264

(22) Filed: Aug. 19, 2002

Related U.S. Application Data
(60) Provisional application No. 60/313,625, filed on Aug. 20, 2001.

(51) Int. Cl. B42F 13/00

(52) U.S. Cl. 402/73

(57) ABSTRACT

A notebook that has a latch for securing the closure of the notebook wherein the latch uses a writing utensil to secure the closure of the notebook. In some embodiments, the latch comprises a loop. The main body of the notebook has an opening that corresponds to the shape of the loop such that when the notebook closes, the loop can substantially pass through the opening. A writing utensil or other instrument shaped like a writing utensil is then inserted into the loop, securing the closure of the notebook. Some embodiments include one or more additional loops through which the writing utensil is inserted.

### RELATED APPLICATIONS

This application claims priority to U.S. Provisional Patent Application Serial No. 60/313,625 filed Aug. 20, 2001, entitled Penlatch Notebook.

### BACKGROUND OF THE INVENTION

1. Field of the Invention

The present invention relates to notebook fasteners. More particularly, the present invention relates to a notebook having a latch for securing the closure of the notebook wherein the latch uses a writing utensil to secure the closure of the notebook.

2. Background and Related Art

Notebooks come in many varieties. Some are large enough to hold hundreds of pages of paper, while others are small enough to fit in one's pocket. Some use rings to securely hold paper while others allow the paper to fit loosely within the main body. Some notebooks can hold pens, PDA's, or other devices. Some notebooks can be secured or fastened to ensure the closure of the notebook by using magnetic clips, zippers, buttons and snaps, while others cannot be fastened or secured. Notebooks that use such fasteners are usually more expensive than those without fasteners. People generally prefer notebooks that can be fastened or secured in order to better secure the contents of the notebook in transit. However, because such notebooks are more expensive, notebooks without fastening mechanisms are often used.

### SUMMARY OF THE INVENTION

The present invention relates to notebook fasteners. More particularly, the present invention relates to a notebook having a latch for securing the closure of the notebook wherein the latch uses a writing utensil to secure the closure of the notebook.

The notebook can be styled in several fashions such as shown in the figures. In a preferred embodiment, the invention comprises a main body having a length and width that allows the main body to act as a cover or protector of an object to be enclosed or enveloped within the main body. For example, where the main body is acting as a cover for a book, the main body will have a length and width sufficient to wrap around or cover the book. The main body has an interior and an exterior side. Projecting from the interior side of the main body is a latch loop. The main body also defines a loop opening that corresponds to the shape of the latch loop such that the loop on the interior side of the main body can substantially pass through the opening. The orientation and positioning of the loop and the corresponding opening can vary.

The journal or book enclosed within the main body can be secured to the interior of the main body using a strap hook and loop attachments, snaps, a pocket, or may fit loosely within the main body. Likewise, the main body may be fitted with a standard ring binder assembly so that loose-leaf papers can be secured within the main body. The main body can also define a second opening to be used as a handle.

The main body may be hinged or made of flexible material so that it can be bent and folded around the book, journal, or other article to be enclosed within the main body. In another embodiment, the latch loop is comprised of two loops, one loop being attached to one end of the main body and the other loop being attached to the opposite end of the main body such that when the main body is folded along its hinge, the two loops can be brought together to form substantially a single loop into which a pen or other writing utensil can be inserted and thereby securely close the notebook. The loop has an interior circumference that allows a writing utensil to be passed through the loop, thereby securely closing and enfolding the object within the main body.

A second loop may also be placed on the exterior side of the main body in alignment with the opening for the latch such that when the notebook is closed, a writing utensil can be placed through the interior and exterior loop latch. This alternative design secures the writing utensil in place and reduces the rotational play on the writing utensil that could damage the loops and the notebook.

While the methods and processes of the present invention have proven to be particularly useful in the area of notebook fasteners, those skilled in the art can appreciate that the methods and processes can be used in a variety of different applications and in a variety of different areas of manufacture to yield fasteners on other devices as laptop computers, briefcases and PDA's.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 provides an illustration of a representative embodiment of the present invention, wherein a latch loop projects from the interior side of the notebook and wherein a metal strap secures a book to the notebook.

FIG. 2 provides an illustration of another representative embodiment of the present invention, wherein a portion of the notebook is folded to create the latch loop and wherein a standard ring binder assembly is used to secure loose-leaf papers inside the notebook.

FIG. 3 provides an illustration of a template of the present invention.

FIG. 4 provides an illustration of a representative penlatch notebook that has a second loop on the exterior side of the notebook.

FIGS. 5A-5C provide illustrations of representative penlatch notebooks that include a handle.

FIGS. 6-10 provide additional illustrations of representative embodiments of the present invention.

### DETAILED DESCRIPTION OF THE INVENTION

The present invention relates to notebook fasteners. More particularly, the present invention relates to a notebook having a latch for securing the closure of the notebook wherein the latch uses a writing utensil to secure the closure of the notebook.

In the disclosure and in the claims the term “notebook” shall refer to a book for notes or memoranda, a book-cover, pocketbook, checkbook, folded sheet-like material or any similar object. The term “writing utensil” shall refer to a pen, pencil, erasure, or any similarly shaped object.

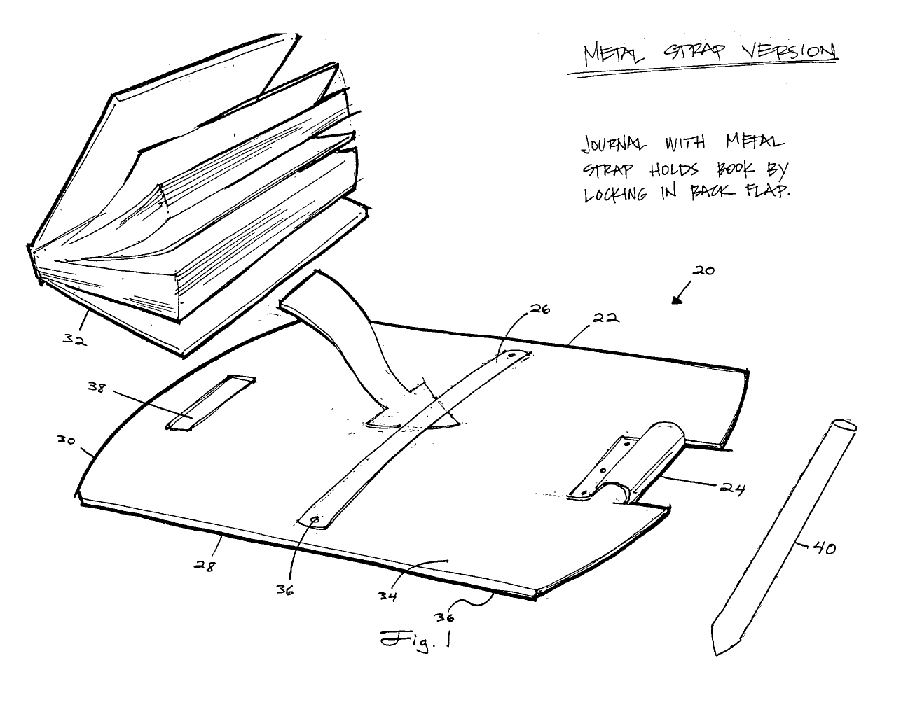

In FIG. 1, the illustrated embodiment includes a notebook 20, which includes a main body 22, a latch loop 24 and a strap 26. The main body 22 has a length 28 and width 30 that allows the main body 22 to act as a cover of a book 32 because the length 28 and width 30 are large enough to wrap around and cover the book 32. The main body 22 has an interior side 34 and an exterior side 36. The strap 26 is attached to the interior side 34 by rivets 36. The book 32 is secured to the interior side 34 of the main body 22 by sliding a portion of the book 32 under a portion of the strap 26.

The main body 22 can then be bent or folded around the book 32 and securely closed through use of the latch loop 24, main body hole 38 and pen 40. In the illustrated embodiment, the main body 22 is configured so that when folded, the latch loop 24 lines up with the main body hole 38, allowing the latch loop 24 to project through the main body hole 38 to the exterior side 36 of the main body 22. The pen 40 is then inserted into the latch loop 24, securing the closure of the notebook 20. While FIG. 1 provides an embodiment in accordance with the present invention that uses a pen to secure the closure of a notebook, those skilled in the art will appreciate that embodiments of the present invention embrace a variety of configurations to use a pen or similarly shaped object to secure the closure of a notebook.

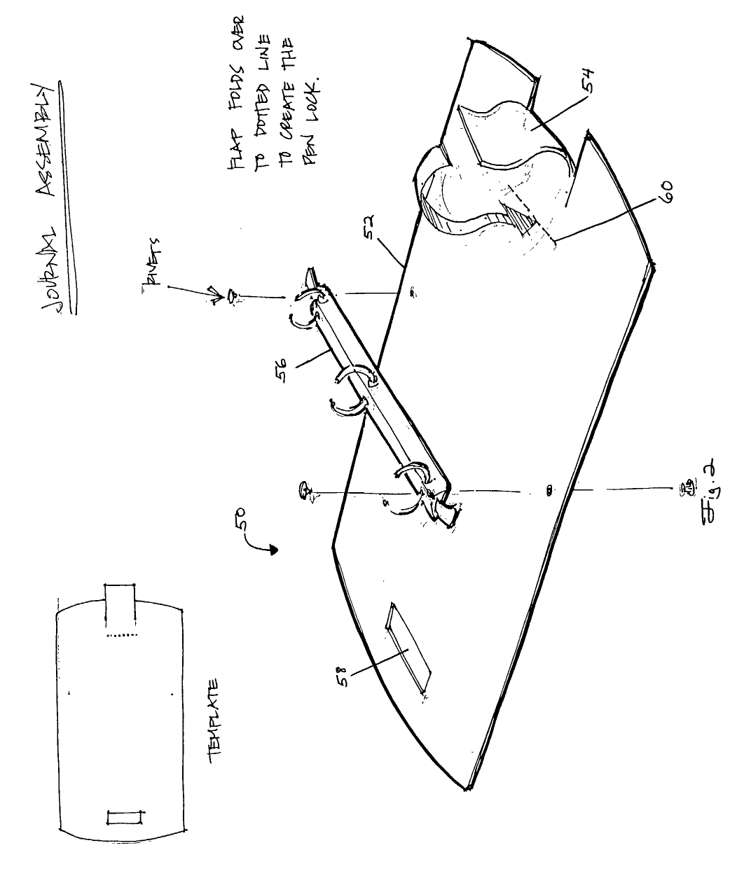

For example, and with reference now to FIG. 2, another representative embodiment is illustrated as notebook 50, which includes a main body 52, a foldable-flap portion of the notebook 54, a standard ring binder assembly 56, and a main body hole 58. The foldable-flap portion of the notebook 54 folds over to dotted line 60 to create the latch loop 24. The standard ring binder assembly 56 is used to secure loose-leaf papers inside the notebook 50.

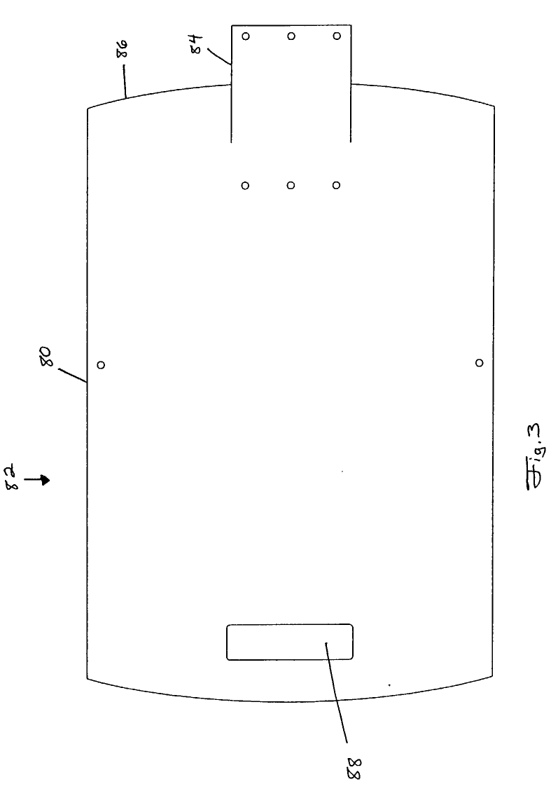

FIG. 3's illustrated embodiment is a template of the present invention. It shows a main body 80 of notebook 82 prior to assembly. A foldable flap portion of the notebook 84 extends beyond edge 86 of the main body 80 to allow the foldable flap portion of the notebook 84 to line up with main body hole 88 after folding.

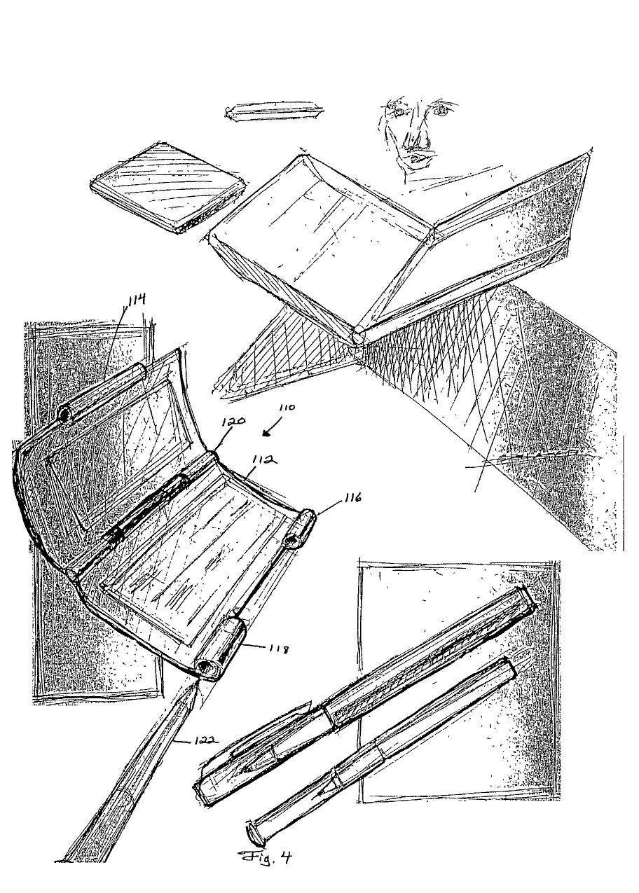

With reference now to FIG. 4, another embodiment of the present invention is illustrated as pocketbook 110, which includes a main body 112, first latch loop 114, second latch loop 116, third latch loop 118 and hinge 120. The hinge 120 enables the pocketbook 110 to close. Once closed, the first latch loop 114 is aligned with the second latch loop 116 and third latch loop 118. A writing utensil 122 is then inserted into the first latch loop 114, second latch loop 116 and third latch lop 118, securing the closure of the pocketbook 110.

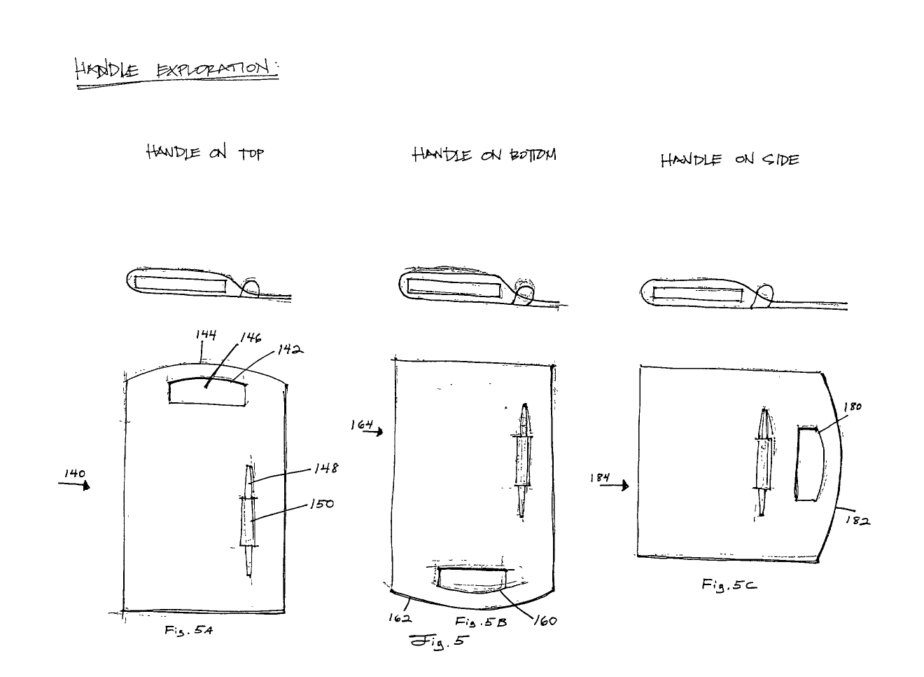

FIGS. 5A-5C provide illustrations of representative penlatch notebooks that include a handle. FIG. 5A illustrates a notebook 140 with a handle 142 on a top portion 144 of the notebook 140. The handle comprises an opening 146 in the notebook 140 that is large enough for a person to grasp. A pen 148 and latch loop 150 are used to secure the closure of the notebook 140. Similarly, FIG. 5B illustrates a handle 160 on a bottom portion 162 of a notebook 164 and FIG. 5C illustrates a handle 180 on a side portion 182 of a notebook 184.

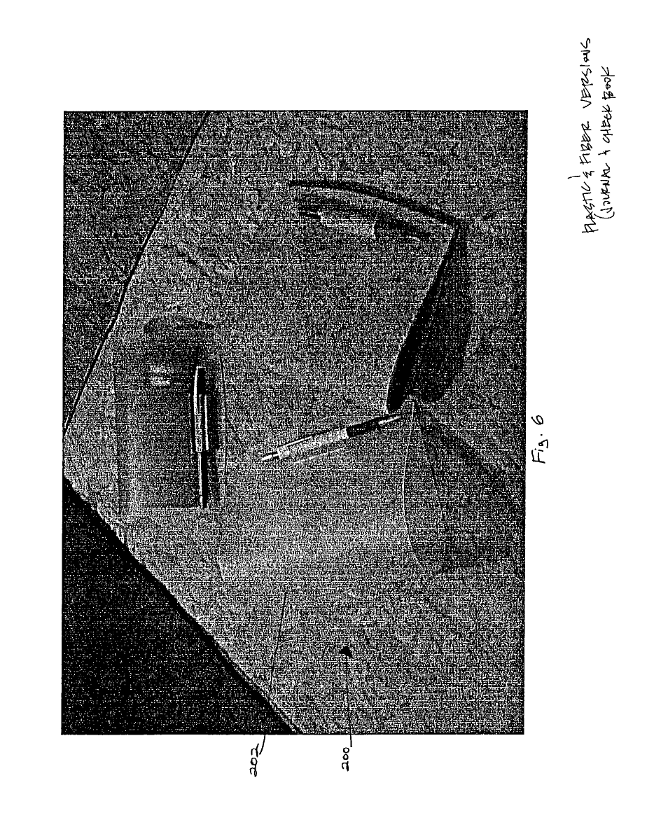

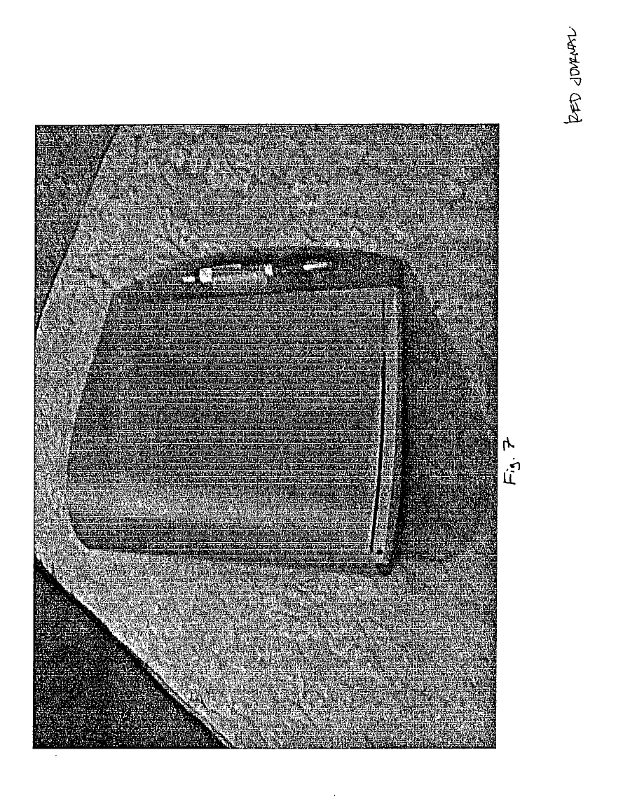

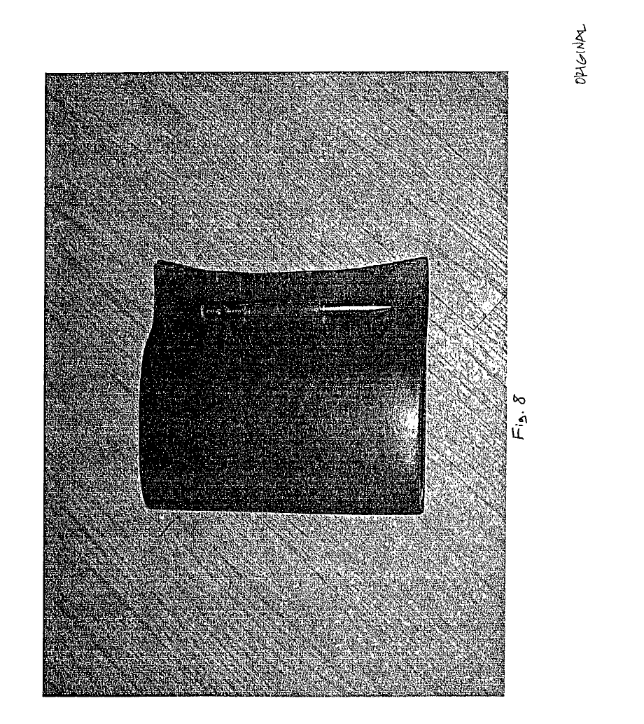

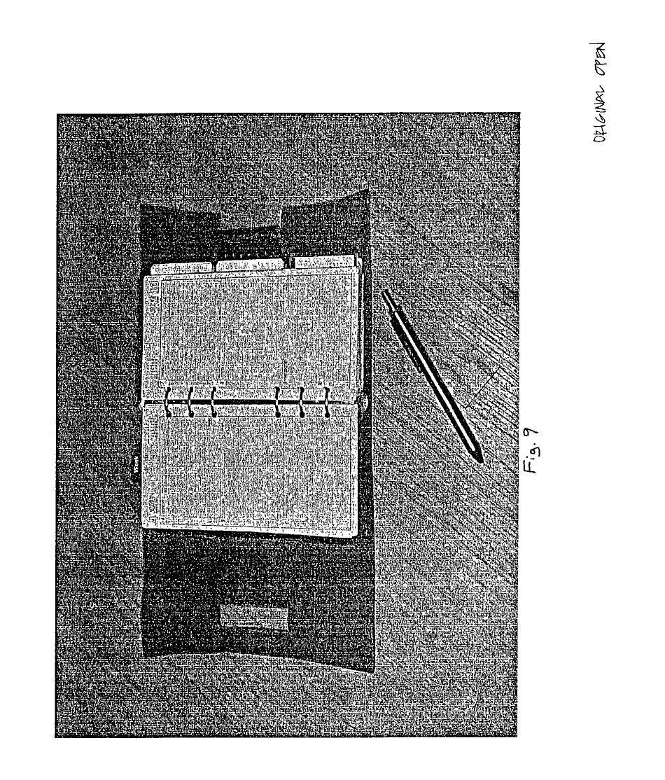

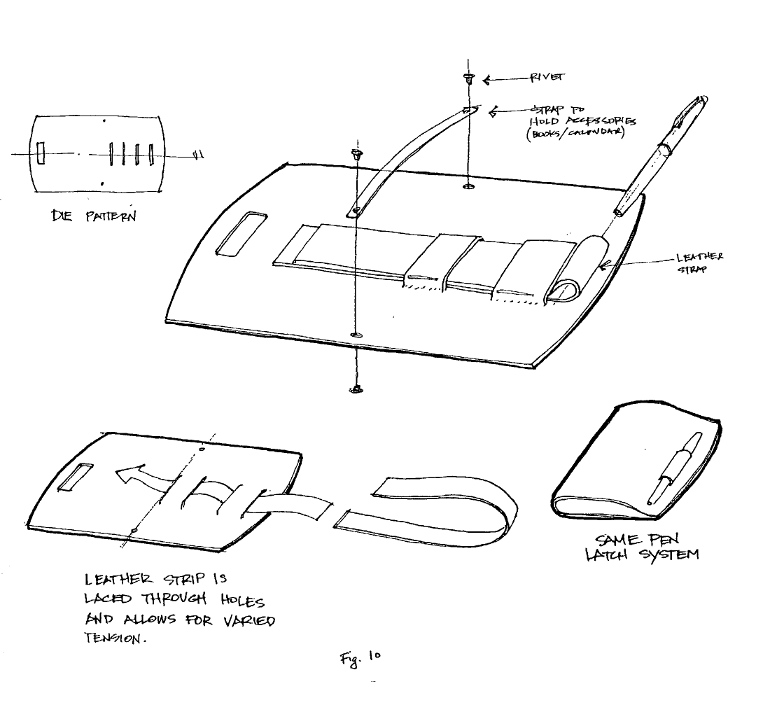

FIG. 6 illustrates a notebook 200 made out of a folded sheet-like material 202. FIGS. 7-9 are additional illustrations of the embodiments described in the figures above.

Thus, as discussed herein, the embodiments of the present invention embrace a notebook having a latch for securing the closure of the notebook wherein the latch uses a writing utensil to secure the closure of the notebook.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A penlatch notebook comprising:
a notebook, and
a latch, wherein the latch uses a writing utensil to secure the closure of the notebook.

2. A penlatch notebook as recited in claim 1, wherein the latch comprises one or more loops.

3. A penlatch notebook as recited in claim 1, wherein the notebook includes an opening that corresponds to the shape of the latch such that when the notebook closes, the latch can substantially pass through the opening.

4. A penlatch notebook as recited in claim 1, wherein the notebook includes a handle.

5. A penlatch notebook as recited in claim 1, wherein the notebook includes a standard ring binder.

6. A penlatch notebook as recited in claim 1, wherein the notebook includes a strap.

7. A method for securing the closure of a notebook, the method comprising the steps for:
closing a notebook, and using a writing utensil to secure the closure of the notebook.

8. A method as recited in claim 7, wherein one or more loops are used to secure the closure of the notebook.

9. A method as recited in claim 7, wherein the step for using a writing utensil further comprises using an opening in the notebook to secure the closure of the notebook.

10. A method as recited in claim 7, wherein the notebook includes a standard ring binder.

11. A method as recited in claim 7, wherein the notebook includes a strap.

12. A penlatch notebook kit comprising:
a notebook;
a writing utensil; and
a latch configured to secure the closure of the notebook by using the writing utensil as a locking mechanism.

13. A penlatch notebook kit as recited in claim 12, wherein the latch comprises one or more loops.

14. A penlatch notebook kit as recited in claim 12, wherein the notebook includes an opening that corresponds to the shape of the latch such that when the notebook closes, the latch can substantially pass through the opening.

15. A penlatch notebook kit as recited in claim 12, wherein the notebook includes at least one handle.

16. A penlatch notebook kit as recited in claim 12, wherein the notebook includes a standard ring binder.

17. A penlatch notebook kit as recited in claim 12, wherein the notebook includes a strap.

18. A penlatch notebook kit as recited in claim 12, wherein the notebook is made of a folded sheet-like material.
